(19) United States
(12) Patent Application Publication
(10) Pub. No.: US 2024/0354642 A1
(43) Pub. Date: Oct. 24, 2024

(54) FINE-TUNING VISION LANGAUGE MODELS WITH UNPAIRED DATA

(71) Applicant: NEC Laboratories America, Inc., Princeton, NJ (US)

(72) Inventors: Vijay Kumar Baikampady Gopalkrishna, Santa Clara, CA (US); Manmohan Chandraker, Santa Clara, CA (US)

(21) Appl. No.: 18/616,930

(22) Filed: Mar. 26, 2024

Related U.S. Application Data
(60) Provisional application No. 63/460,932, filed on Apr. 21, 2023.
(60) Provisional application No. 63/467,357, filed on May 18, 2023.

(51) Int. Cl. G06N 20/00

(52) U.S. Cl. CPC G06N 20/00

(57) ABSTRACT

Methods and systems for fine-tuning a model include generating a label space for a target domain. Text pseudo-labels are generated for images in an unlabeled dataset from the target domain based on the label space using a pre-trained vision language model. The pre-trained vision language model is fine-tuned for the target domain using the images with the text pseudo-labels.

This application claims priority to U.S. Patent Application No. 63/460,932, filed on Apr. 21, 2023, and to U.S. Patent Application No. 63/467,357, filed on May 18, 2023, each incorporated herein by reference in its entirety.

### BACKGROUND

### Technical Field

The present invention relates to machine learning systems and, more particularly, to vision language models.

### Description of the Related Art

Vision language models may be trained on extensive sets of image-text p airs using self-supervised techniques, allowing them to establish strong connections between visual and linguistic concepts. Being trained on data from multiple domains, these models can perform well in a zero-shot manner on domains where they have not been explicitly trained.

### SUMMARY

A method for fine-tuning a model includes generating a label space for a target domain. Text pseudo-labels are generated for images in an unlabeled dataset from the target domain based on the label space using a pre-trained vision language model. The pre-trained vision language model is fine-tuned for the target domain using the images with the text pseudo-labels.

A method for fine-tuning a model includes generating a label space for a target domain. Generating the label space includes determining similarity values between tokens in a list of tokens and generating a bag of words representation based on tokens that have an above-threshold similarity value, combining bag of words representations for all images in the unlabeled dataset to generate a bag of words representation for the entire unlabeled dataset, pruning words from the bag of words representation for the entire unlabeled dataset based on a frequency of occurrence, and pruning words from the bag of words representation for the entire unlabeled dataset based on an above-threshold degree of similarity to other words from the bag of words representation. Text pseudo-labels are generated for images in an unlabeled dataset from the target domain based on the label space using a pre-trained vision language model. The pre-trained vision language model is fine-tuned for the target domain using the images with the text pseudo-labels.

A system for fine-tuning a model includes a hardware processor and a memory that stores a computer program. When executed by the hardware processor, the computer program causes the hardware processor to generate a label space for a target domain, to generate text pseudo-labels for images in an unlabeled dataset from the target domain based on the label space using a pre-trained vision language model, and to fine-tune the pre-trained vision language model for the target domain using the images with the text pseudo-labels.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an exemplary environment with video monitoring and automated image processing, in accordance with an embodiment of the present invention;

FIG. 2 is a block diagram of a system for video monitoring using a vision language model, in accordance with an embodiment of the present invention;

FIG. 3 is a block/flow diagram of a method for fine-tuning a pre-trained vision language model, in accordance with an embodiment of the present invention;

FIG. 4 is a block diagram of a computer system that can fine-tune and use a vision language model, in accordance with an embodiment of the present invention;

FIG. 5 is a diagram of a neural network architecture that can be used as part of a vision language model, in accordance with an embodiment of the present invention; and

FIG. 6 is a diagram of a neural network architecture that can be used as part of a vision language model, in accordance with an embodiment of the present invention.

### DETAILED DESCRIPTION OF PREFERRED EMBODIMENTS

Vision language models may benefit from fine-tuning on domain-specific data in some instances. However, this can be difficult when there is a significant amount of data from the target domain that is unpaired. For example, there may be a large number of satellite images available, but without textual labels. This makes it impossible to fine-tune vision language models that use paired data without a time-consuming labeling process.

To generate paired date for fine-tuning, a label space for the target domain may be established. Nearest neighbors from the generated, domain-specific label space may be pruned and paired data may be created for each target-domain image. The model may then be fine-tuned on this paired data, using the generated pseudo-labels to prepare the model for use in the target domain.

For example, such models may be used for image recognition that makes use of both visual similarity and textual descriptions. In an exemplary embodiment, a dataset of images of tattoos may be processed to apply descriptive labels. These labels aid an image recognition model in identifying variations and different instances of the tattoo's theme, even when the particular artwork differs significantly. In another exemplary embodiment, an aerial image dataset may be labeled in this manner, and a model may be fine-tuned to provide new labels to input images. The fine-tuned vision language model can provide semantic information relating to visual inputs for a target domain.

Referring now to FIG. 1, an exemplary monitored environment 100 is shown. The environment 100 shows two regions, including an uncontrolled region 102 and a controlled region 104. It should be understood that this simplified environment is shown solely for the sake of illustration, and that realistic environments may have many such regions, with differing levels of access control. For example, there may be multiple distinct controlled regions 104, each having different sets of authorized personnel with access to them. In some embodiments, regions may overlap.

A boundary is shown between the uncontrolled region 102 and the controlled region 104. The boundary can be any appropriate physical or virtual boundary. Examples of physical boundaries include walls and rope-anything that establishes a physical barrier to passage from one region to the other. Examples of virtual boundaries include a painted line and a designation within a map of the environment 100. Virtual boundaries do not establish a physical barrier to movement, but can nonetheless be used to identify regions with differing levels of control. A gate 106 is shown as a passageway through the boundary, where individuals are permitted to pass between the uncontrolled region 102 and the controlled region 104.

A number of individuals are shown, including unauthorized individuals 108, shown as triangles, and authorized individuals 110, shown as circles. Also shown is an forbidden individual 112, shown as a square. The unauthorized individuals 108 are permitted access to the uncontrolled region 102, but not to the controlled region 104. The authorized individuals are permitted access to both the uncontrolled region 102 and the controlled region 104. The forbidden individual 112 may not be permitted in either the controlled region 104 or the uncontrolled region 102.

The environment 100 is monitored by a number of video cameras 114. Although this embodiment shows the cameras 114 being positioned at the gate 106, it should be understood that such cameras can be positioned anywhere within the uncontrolled region 102 and the controlled region 104. The video cameras 114 capture live streaming video of the individuals in the environment, and particularly of those who attempt to enter the controlled region 104.

The video streams generated by the video cameras 114 may be processed to identify objects within the frames of the video streams. Any kind of processing may be performed on the video streams, for example to identify tattoos, faces, vehicles, license plates, animals, etc. The detected object may be compared to objects in a watchlist. In the case of faces, a similarity metric may be used to compare a detected face from a frame of the video streams to a set of different faces that are stored in the watchlist.

In a particular example, the video streams may be processed to identify a particular tattoo or tattoo style. In such an example, the tattoo or tattoo style may be known by law enforcement to be associated with criminal activity. A tattoo recognition system may be based on a visual language model that is fine-tuned using a tattoo dataset. Recognition of a particular tattoo or style of tattoo may be used to trigger a security response, for example barring entry through the gate 106 and/or summoning law enforcement to intercept a forbidden individual 112.

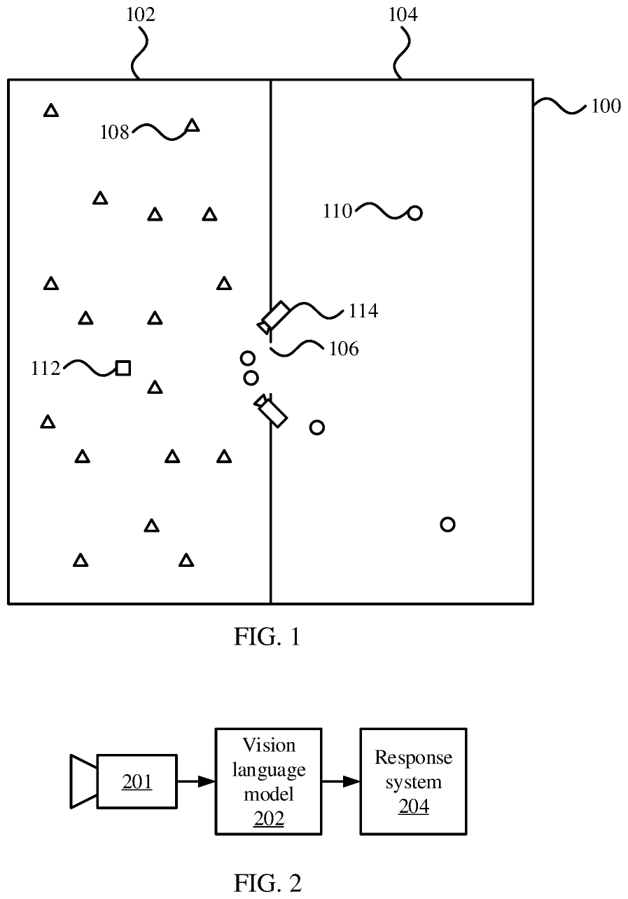

Referring now to FIG. 2, a video processing pipeline is shown. A camera 201 captures still images or a video stream showing a particular environment. Images from the video stream are processed by the visual language model 202, for example to perform a classification or labeling task on the images. As described above, the visual language model 202 may be configured to identify a particular tattoo within the scene, or may be configured to add labels to aerial photos that identify features visible within an image.

Based on the output of the visual language model 202, response system 204 takes some responsive action. In the example of FIG. 1, the responsive action may be to control the operation of the gate 106, to take some other automated security action, or to summon law enforcement authorities. In examples that focus on identifying features in aerial photographs, the response system 204 may send relief to people suffering from a natural disaster.

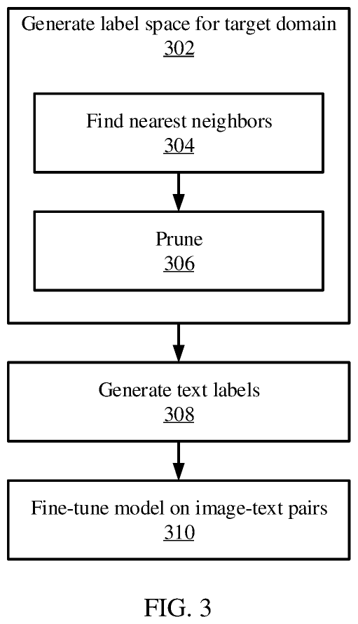

Referring now to FIG. 3, a method of fine-tuning a vision language model 202 is shown. In a vision language model that includes a text encoder, input text may be tokenized into smaller units, such as words or sub-words. These tokens are assigned unique embeddings that are used to represent the text. For example, there may be tens of thousands of tokens in a label space to represent various parts of speech, such as nouns, verbs, adjectives, and articles.

To obtain a label space in block 302, tokens may be removed from a default set, such as punctuation, special symbols, and plural forms. This new list of tokens may be used to represent the text. For each image in a training dataset, the tokens that have a similarity value above a certain threshold are computed in block 304 and a bag of words representation is created for the image. This process is repeated for all images in the dataset, and the bag of words representations for each image are accumulated to obtain a final bag of words representation for the entire dataset. This final representation indicates the frequency of the nearest tokens in the dataset.

To find the tokens that are closest to the unlabeled image, a model that is pre-trained on image-text pairs may be used. The model may be trained from many images, from different domains, to generate the pseudo-labels. The same model may then be used for the fine-tuning using the new images with its own pseudo-labels.

Words that appear most in the images are pruned out by block 306, as they are unlikely to provide informative labels. For example, in an aerial dataset, words like “aerial,” “satellite,” and “top-view” may appear frequently but do not provide information about the content of the image. This may be determined by comparing word frequency to a threshold value based on the number of images available in the target domain. For example, if a word occurs in more than 30% of images, then it may not provide much information about the image. Alternatively, a domain expert may manually determine what words to remove.

Additionally, unrelated words that occur in fewer than a first threshold percentage of the images may also be pruned. Words that have similarity scores greater than a second threshold may be pruned to remove words with substantially identical meanings. Each word may have a corresponding embedding vector that can be compared to the vectors of other words to determine a semantic similarity using an appropriate metric, such as the cosine similarity. The resulting set of tokens forms a final label space for the vision language model, which can be used to classify new images based on their nearest tokens.

Block 308 generates text labels for unlabeled images in a dataset from a target domain. For each image, words from the final label space of block 302 are used identify the nearest words. The words within a threshold of the image are considered as the label space of the image, and they may be concatenated to form a pseudo-label. For example, if the nearest words to an image are “road,” “city,” and “urban,” then the final label for the image may be “{road city urban}”. This pseudo-label is associated with the image as an image-text pair.

To determine whether a given word is close to the image, the vision-language model can be used to determine embeddings for the text as well as the image, in a shared latent space. For each word, the embeddings are determined and compared to image embeddings to find the closest words, for example using a cosine similarity or other appropriate similarity metric.

Block 310 uses the dataset of images and associated pseudo-labels to fine-tune the vision language model 202 for the target domain. The vision model 202 may be pre-trained according to one or more original domains that are distinct from the target domain in some fashion. For example, the vision language model 202 may be trained on color images, while the target domain includes only black-and-white images. In another example, the vision language model 202 may be trained on images taken from a particular angle (e.g., horizontally), while the target domain may include images taken from a different angle (e.g., overhead). Thus the domains at issue may differ by content, environment, camera settings, or along any other dimension.

This fine-tuning process may freeze parameters of a text encoder in the vision language model 202, so that only a vision encoder of the model 202 is affected. This may be done to prevent noise from the pseudo-labels from being introduced into the text encoding of the model.

Following the example of recognizing tattoos, tattoos that are known to belong to members of a same criminal organization may be grouped together to identify the dominant concepts associated with that organization. For example, a given organization may make frequent use of particular imagery in their tattoos, and these concepts can be assigned as text pseudo-labels to the corresponding images. Descriptions of the tattoos may also be parsed into a bag of words using the label space generated for the tattoos. Image similarity may then be used to find tattoos that are visually similar to a given image to assign the dominant concepts in the bag of words representation as a pseudo-label.

Following the example of processing aerial images, bounding boxes and segmentations can be used to identify particular structures and features in the images. These boxes can be labeled with text descriptions such as, “house,” “airport,” “road,” or “bridge.” These pseudo-labels may further be concatenated to form pseudo-labels, which may be used to derive super-category labels, such as “residential,” “urban,” or “rural.” These super-category labels may be added, along with the category labels, to obtain an enriched pseudo-label. Label information may further include positional relationship information, for example indicating the location of a road relative to structures in the image.

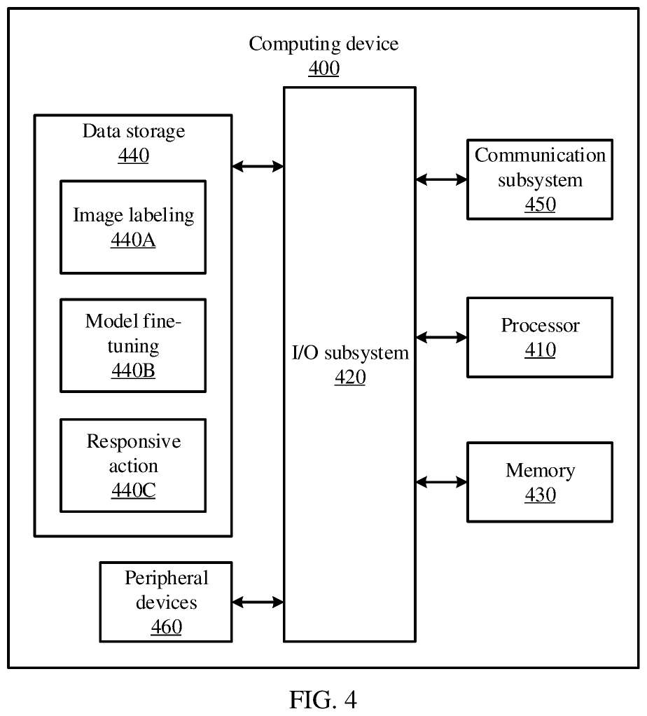

Referring now to FIG. 4, an exemplary computing device 400 is shown, in accordance with an embodiment of the present invention. The computing device 400 is configured to fine-tune a vision language model.

The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for image labeling, 440B for fine-tuning the vision language model, and/or 440C for performing an automatic action responsive to the model's output. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

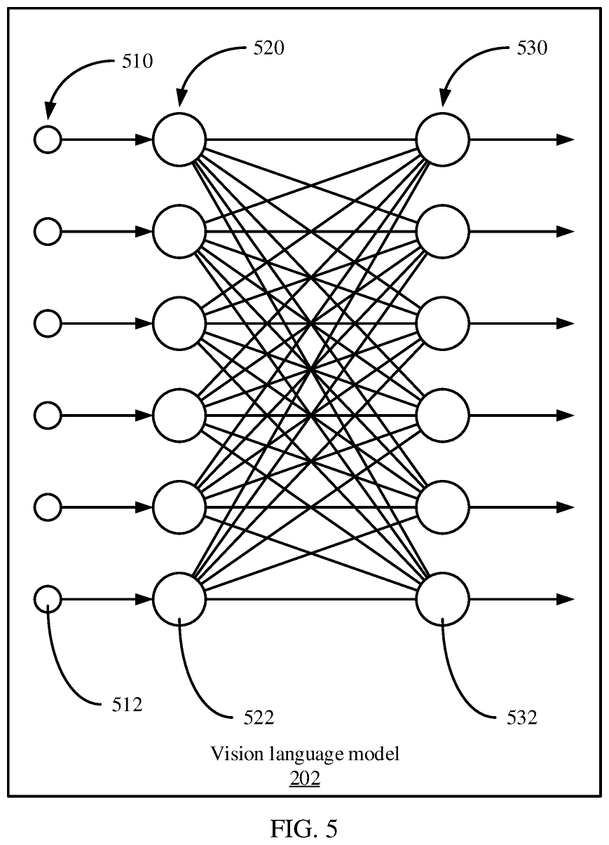

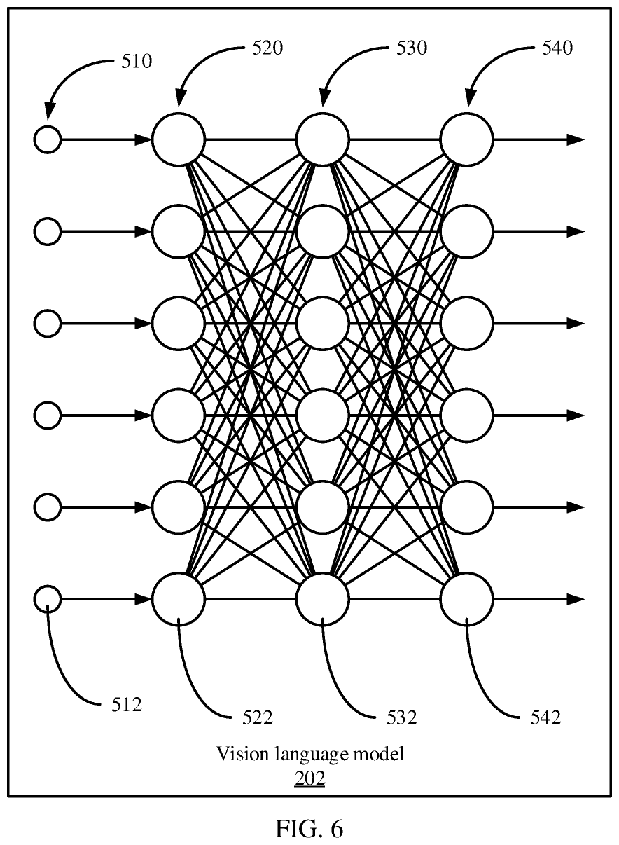

Referring now to FIGS. 5 and 6, exemplary neural network architectures are shown, which may be used to implement parts of the present models, such as the vision language model 202. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor—or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for fine-tuning a model, comprising:
generating a label space for a target domain;
generating text pseudo-labels for images in an unlabeled dataset from the target domain based on the label space using a pre-trained vision language model; and
fine-tuning the pre-trained vision language model for the target domain using the images with the text pseudo-labels.

2. The method of claim 1, wherein generating the label space includes pruning a list of tokens to remove tokens that represent punctuation, special symbols, and plural forms.

3. The method of claim 1, wherein generating the label space includes determining similarity values between tokens in a list of tokens and generating a bag of words representation based on tokens that have an above-threshold similarity value.

4. The method of claim 3, wherein generating the label space further includes combining bag of words representations for all images in the unlabeled dataset to generate a bag of words representation for the entire unlabeled dataset.

5. The method of claim 4, wherein generating the label space further includes pruning words from the bag of words representation for the entire unlabeled dataset based on a frequency of occurrence.

6. The method of claim 4, wherein generating the label space further includes pruning words from the bag of words representation for the entire unlabeled dataset based on an above-threshold degree of similarity to other words from the bag of words representation.

7. The method of claim 1, wherein the pre-trained vision language model is pre-trained on images from an original domain that is different from the target domain.

8. The method of claim 7, wherein the target domain differs from the original domain in at least one respect selected from the group consisting of color range, visual angle, content, environment, and camera settings.

9. The method of claim 1, further comprising processing a new image in the target domain using the fine-tuned vision language model to generate a label for the new image and performing an action responsive to the label.

10. The method of claim 1, wherein the action is selected from the group consisting of controlling access to a secure area, performing an automated security action, and sending relief to people suffering from a natural disaster.

11. A computer-implemented method for fine-tuning a model, comprising:
generating a label space for a target domain, including:
determining similarity values between tokens in a list of tokens and generating a bag of words representation based on tokens that have an above-threshold similarity value;
combining bag of words representations for all images in an unlabeled dataset to generate a bag of words representation for the entire unlabeled dataset;
pruning words from the bag of words representation for the entire unlabeled dataset based on a frequency of occurrence; and
pruning words from the bag of words representation for the entire unlabeled dataset based on an above-threshold degree of similarity to other words from the bag of words representation;
generating text pseudo-labels for images in an unlabeled dataset from the target domain based on the label space using a pre-trained vision language model; and
fine-tuning the pre-trained vision language model for the target domain using the images with the text pseudo-labels.

12. A system for fine-tuning a model, comprising:
a hardware processor; and
a memory that stores a computer program which, when executed by the hardware processor, causes the hardware processor to:
generate a label space for a target domain;
generate text pseudo-labels for images in an unlabeled dataset from the target domain based on the label space using a pre-trained vision language model; and
fine-tune the pre-trained vision language model for the target domain using the images with the text pseudo-labels.

13. The system of claim 12, wherein the computer program further causes the hardware processor to prune a list of tokens to remove tokens that represent punctuation, special symbols, and plural forms.

14. The system of claim 12, wherein the computer program further causes the hardware processor to determine similarity values between tokens in a list of tokens and generating a bag of words representation based on tokens that have an above-threshold similarity value.

15. The system of claim 14, wherein the computer program further causes the hardware processor to combine bag of words representations for all images in the unlabeled dataset to generate a bag of words representation for the entire unlabeled dataset.

16. The system of claim 15, wherein the computer program further causes the hardware processor to prune words from the bag of words representation for the entire unlabeled dataset based on a frequency of occurrence.

17. The system of claim 15, wherein the computer program further causes the hardware processor to prune words from the bag of words representation for the entire unlabeled dataset based on an above-threshold degree of similarity to other words from the bag of words representation.

18. The system of claim 12, wherein the pre-trained vision language model is pre-trained on images from an original domain that is different from the target domain.

19. The system of claim 18, wherein the target domain differs from the original domain in at least one respect selected from the group consisting of color range, visual angle, content, environment, and camera settings.

20. The system of claim 12, wherein the computer program further causes the hardware processor to process a new image in the target domain using the fine-tuned vision language model to generate a label for the new image and performing an action responsive to the label, the action being selected from the group consisting of controlling access to a secure area, performing an automated security action, and sending relief to people suffering from a natural disaster.
